(19) United States
(12) Patent Application Publication
(10) Pub. No.: US 2009/0039224 A1
(43) Pub. Date: Feb. 12, 2009

(54) Extension arm devices and methods of manufacture

(75) Inventor: Robert Altonji, Quakertown, PA (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Innovative Office Products, Inc., Easton, PA (US)

(21) Appl. No.: 11/891,483

(22) Filed: Aug. 10, 2007

(51) Int. Cl. F16M 11/12; B21D 39/04; B22D 19/00

(52) U.S. Cl. 248/276.1; 164/6; 29/428

(57) ABSTRACT

The present invention provides enhanced extension arm assemblies for supporting various user devices such as flat panel displays and other equipment. The extension arm assemblies include endcaps that connect to a mounting device or to other equipment. In order to stably support the weight of the user device, the endcap, and in particular the endcap shaft, needs to be fabricated accordingly. In one embodiment, the shaft of the endcap has an enhanced cruciform configuration where corners along the shaft are radiused or otherwise curved. In another embodiment, the endcap shaft is formed of wrought steel and the main body of the endcap is cast onto the shaft. These shaft configurations provide superior strength and stability. Another endcap configuration integrally casts a tube with the endcap body and provides enhanced range of motion for the extension arm. Methods of manufacturing these devices are also provided.

### BACKGROUND OF THE INVENTION

The present invention relates to equipment for use in mounting, supporting and displaying electronic devices. More particularly, the present invention is particularly adapted for use in adjustable extension arm apparatuses coupled to electronic devices such as flat panel displays, CRTs, keyboards, test equipment, laptop computers, tablet computers and other user devices.

It is often desirable to position user devices or equipment such as video displays, keyboards, mouse-type devices, etc. about a workspace or other location to give maximum comfort and ease of use to the user. For instance, such equipment can be placed on desks, tabletops, or upon other equipment such as personal computers or workstations.

One drawback to these configurations is the reduction in available workspace taken up by the equipment. Another drawback is the inability to place the equipment in a desired location. A further drawback is the potential for eye strain, neck strain and/or a cumulative trauma disorder such as carpel tunnel syndrome from poor placement of devices such as monitors and keyboards.

Different solutions have been provided in order to overcome these obstacles. For example, in one solution, a monitor stand or printer stand elevates the apparatus over other equipment on a desk. While this may free up workspace, it often places the equipment in an undesirable location or a fixed position. Another solution employs a mechanical extension arm to support the monitor. Extension arms free up workspace and allow users to place the equipment where it is wanted. One such extension arm is shown and described in U.S. Pat. No. 6,478,274, entitled “Arm Apparatus for Mounting Electronic Devices,” which is fully incorporated by reference herein. Another type of extension arm is shown and described in U.S. Pat. No. 6,409,134, entitled “Arm Apparatus for Mounting Electronic Devices with Cable Management System,” which is fully incorporated by reference herein. Other extension arms are shown and described in U.S. Pat. No. 7,100,880, entitled “Arm Apparatus for Mounting Electronic Devices with Cable Management System,” which is fully incorporated by reference herein.

FIG. 1(a) illustrates a known extension arm 10 that can be connected at one end to a mounting assembly (not shown) and attached to a tilting device 12 at the other end for supporting a monitor 14 or other electronic user device. The mounting assembly may be of any desired configuration, and may be affixed to a piece of furniture such as a desk, a wall such as a slat wall, a section of an office cubicle, etc. A cable 16 is connected to the electronic device 14 at one end and has a plug or other connector 18 at the other end for connection to a power supply, networking hub or another electronic device such as a personal computer. While the electronic user device 14 is described below as a monitor such as a flat panel or other video display, the invention is not limited to use with such devices, and may be used with a wide variety of electrical and mechanical equipment, including non-powered equipment.

The extension arm 10 may be a conventional extension arm or any other suitable mounting device. Preferably, the extension arm 10 is one of the types fully described in above-referenced U.S. Pat. Nos. 6,409,134 and 6,478,274. As shown in FIG. 1, the extension arm 10 may include a first endcap 20, an arm 22, a second endcap 24 and a forearm extension 26.

The first endcap 20 includes a housing attached to one end of the arm 22 by, for example, pins. A shaft 28 or other connection device is adapted for connection to the mounting assembly. The shaft 28 may be integrally molded with an endwall of the housing of the first endcap 20, and may be fabricated as a single part such as of aluminum. Alternatively, the shaft 28 may be securely attached to the housing of the first endcap 20.

The arm 22 is formed of an upper housing 22a and a lower housing 22b. The upper housing 22a and the lower housing 22b define a chamber therebetween containing, for example, a gas spring (not shown). The gas spring is adjustably mounted at one end within the first endcap 20 and at the other end to, for example, a ball stud mounted within the upper housing 22a. The cable 16 may be secured within the arm 22 as shown and described in U.S. Pat. No. 6,409,134. Alternatively, the arm 22 may include one or more external cable ties in order to secure the cable 16 of the electronic device 14 supported by the extension arm 10.

The second endcap 24 has a housing attached to the second end of the arm 22 by, for example, pins. A shaft (not shown) may extend out of the top of the housing of the second endcap 24 and connect to the forearm extension 26. The forearm extension 26 includes a body 30 having an interior channel, as well as a first end 32 and a second end 34. The forearm extension 26 may be rotatable about an axis of the first end 32.

The upper housing 22a, the lower housing 22b, the first endcap 20 and the second endcap 24 are configured so as to form an adjustable parallelogram. When configured, the housing of the first endcap 20 and the housing of the second endcap 24 point in opposite directions. The shape of the parallelogram is retained by the gas spring within the chamber of the arm 22. Generally, the gas spring is sized so as to have a fixed length until an upward or downward force is exerted at the second endcap 24 that exceeds the gas spring's designed resistance. Thus, the gas spring retains the parallelogram shape when the only force exerted at the second endcap 24 is the weight of the electronic device 14. However, the gas spring permits the parallelogram shape to be adjusted when a user pushes the electronic device 14, which is preferably coupled to the forearm extension 26 by means of the tilting device 12, up or down. The tilting device 12 can be directly connected to the endcap 24 or to the second end 34 of the forearm extension 26, and may be rotatable thereabout. The tilting device 12 may comprise known components, such as those shown and described in U.S. Pat. No. 6,505,988, the entire disclosure of which is hereby incorporated by reference herein.

The aforementioned extension arms are particularly beneficial when positioning and/or adjusting user equipment in a work environment. The user is able to quickly and efficiently position a video display terminal or other equipment while he or she is situated at a desk or lab table, for example. Notwithstanding the benefits of such extension arm devices, it is desirable to reduce manufacturing complexity, enhance durability and reduce the cost of manufacture. For instance, the endcaps of the extension arm may be placed under heavy loads and stresses. The materials used and the methods of fabricating the endcaps and associated components should be tailored to meet such needs to provide a quality product that can be easily made at reasonable cost. The present invention addresses these and other needs, as explained in detail herein.

### SUMMARY OF THE INVENTION

In accordance with one embodiment of the present invention, a method of fabricating an adjustable extension arm assembly comprises forming a hollow tube structure having a first end, a second end, and at least one generally annular recess disposed about an exterior surface between the first and second ends of the tube structure. A mold is coupled to the hollow tube structure. A first endcap body is cast to form a unitary structure with the tube structure by applying liquid material to the mold so that the first endcap body mechanically bonds to the at least one generally annular recess about the exterior surface of the tube structure, And an adjustable extension arm member is fixed to the tube structure.

In one alternative, forming the hollow tube structure includes forming an exposed groove about the exterior surface of the tube structure and apart from the at least one generally annular recess. This may further comprise placing a thrust washer about a first portion of the tube structure and securing a snap ring to the exposed groove. In this case, the method may further comprise, prior to affixing the adjustable extension arm member to the tube structure, fitting a bushing into a bore of the adjustable extension arm member. Here, the bore of the adjustable extension arm member desirably includes a shoulder disposed along the interior surface of the bore remote from first and seconds ends thereof. Thus, fitting the bushing into the bore includes inserting the bushing into the bore until the bushing abuts the shoulder in this case.

In another alternative, the tube structure includes a bird mouth opening at the first end of the first endcap body. The first endcap body is cast to include an arcuate bridge member disposed over and conforming in shape to the generally arcuate bird mouth opening of the tube structure.

In accordance with another embodiment of the present invention, an extension arm assembly comprises a unitary endcap assembly and a forearm extension. The unitary endcap assembly includes a wrought tube structure having a first end, a second end, and at least one generally annular recess disposed about an exterior surface between the first and second ends of the tube structure. The tube structure includes a generally arcuate bird mouth opening at the first end thereof. The unitary endcap assembly also includes a cast first endcap body having a pair of sidewalls connected at one end by an arcuate bridge member and connected at another end by a second bridge member. The first endcap body has an opening at the first end and including at least one generally annular protrusion about an interior surface of the first end. The at least one generally annular protrusion is mechanically bonded to the at least one generally annular recess of the tube structure and the arcuate bridge member conforming in shape to the generally arcuate bird mouth opening of the tube structure. The forearm extension has a first end and a second end opposite the first end. The first end includes a bore therethrough. The forearm extension is affixed at the bore to the second end of tube structure opposite the first endcap body.

In one alternative, the forearm extension includes a shoulder disposed along the interior surface of the bore, with the shoulder being remote from either end of the bore. Here, the extension arm assembly further comprises a bushing disposed in the bore along a first side of the shoulder and between the interior surface of the bore and the exterior surface of the tube structure. Here, the extension arm assembly may further comprise a washer disposed about the tube structure and between the first end of the endcap body and the first end of the forearm extension. In another example, the extension arm assembly further comprises a thrust washer disposed about the tube structure adjacent a second side of the shoulder. In this case, a thrust load applied to the extension arm assembly is directly applied to the tube structure and is not directly applied to the bushing.

In another alternative, the extension arm assembly preferably further comprises first and second channel members as well as a second endcap assembly. The first channel member has a first end, a second end opposite the first end, and a pair of sidewalls extending from the first end to the second end. The second channel member has a first end, a second end opposite the first end, and a pair of sidewalls extending from the first end to the second end. The second endcap assembly has first and second ends, with the first end being adjustably coupled to the second ends of the first and second channel members. The first ends of the first and second channel members are adjustably coupled to the pair of sidewalls of the first endcap body. The generally arcuate bird mouth opening of the tube structure and the arcuate bridge member of the first endcap body provide clearance for the first ends of the first and second channel members to extend fully between a first position and a second position through a maximum range of at least about 90°. In a preferred example, the maximum range is between about 110° to 130°, although ranges greater than 130° or between 90° and 110° are also possible.

In accordance with yet another embodiment of the present invention, a method of fabricating an endcap device for use in an adjustable extension arm is provided. The method comprises forming a shaft member by machining a metal rod. The shaft member has a first end and a second end opposite the first end. The first end includes a connection region with a recessed area therealong, and the recessed area having a generally annular configuration. The method also comprises coupling a mold to the first end of the shaft member including the connection region. The method further comprises casting an endcap body using the mold to form a unitary structure with the shaft member by applying liquid metal to the mold. The endcap body is cast to include a first end, a second end opposite the first end, a pair of sidewalls disposed between the first and second ends and an opening therebetween along one side of the endcap body. The first end includes a receptacle therein. The receptacle includes an inner section, an outer section and a middle section therebetween. And the middle section has a generally annular protrusion mechanically bonded to the recessed area of the shaft member connection region.

In one alternative, the shaft member includes a generally cylindrical shaft extending from the first end of the endcap body, the shaft having an area moment of inertia of at least 0.09 in⁴. In another alternative, the shaft member is formed of wrought steel and the shaft has a stiffness of at least 1.45×10⁶ lb-in². In a further alternative, the generally annular configuration of the connection region recessed area includes radiused edges set at an angle of at least 15° with respect to one another.

In accordance with a another preferred embodiment of the present invention, an endcap assembly comprises a case endcap body and a shaft member. The cast endcap body has a first end, a second end opposite the first end, pair of sidewalls disposed between the first and second ends and an opening therebetween along one side of the endcap body. The first end includes a receptacle therein. The receptacle includes an inner section, an outer section and a middle section therebetween, with the middle section having a generally annular protrusion therealong. The shaft member has a connection region at a first end thereof mechanically bonded to the inner, middle and outer sections of the receptacle to form a unitary structure therewith. The connection region includes a generally annular recessed member coupled to the generally annular protrusion of the receptacle. The shaft member also includes a generally cylindrical shaft at a second end thereof remote from the first end of the endcap body. And the shaft has an area moment of inertia of at least 0.09 in⁴.

In one example, the shaft member is formed of wrought steel and the shaft has a stiffness of at least 1.45×10⁶ lb-in². In another example, the generally annular protrusion of the receptacle includes radiused edges that connect to the inner and outer sections. In this case, the radiused edges are set at an angle of at least 20° with respect to one another.

In accordance with yet another preferred embodiment of the present invention, an integral one-piece endcap for use with an extension arm assembly is provided. The endcap comprises an endcap body and a shaft member. The endcap body has a first end, a second end opposite the first end, a pair of sidewalls disposed between the first and second ends and an opening therebetween along one side of the endcap body. The shaft member has a first shaft section formed as an integral one-piece member with the first end of the endcap body and a second shaft section remote from the first end of the endcap body. The first shaft section includes a first set of cruciform members and the second shaft section including a second set of cruciform members. All corners and edges of the first and second sets of cruciform members are fully radiused to reduce stress concentrations therealong.

In one alternative, the first set of cruciform members has a longer length than the second set of cruciform members.

In accordance with a further embodiment of the present invention, an endcap for use with an extension arm assembly is provided. In this embodiment, the endcap comprises an endcap body having a first end, a second end opposite the first end, a pair of sidewalls disposed between the first and second ends and an opening therebetween along one side of the endcap body. The endcap also comprises shaft means fixedly secured with the first end of the endcap body.

### BRIEF DESCRIPTION OF THE DRAWINGS

FIG. 1 illustrates a conventional extension arm assembly.

FIGS. 2A-2C illustrate a conventional endcap for an extension arm.

FIGS. 3A-3D illustrate an endcap assembly in accordance with aspects of the present invention.

FIGS. 3E-3G illustrate the moment of inertia for various endcap shaft configurations.

FIGS. 4A-4B illustrate another endcap assembly in accordance with aspects of the present invention.

FIGS. 5A-E illustrate components of the endcap assembly of FIGS. 4A-4B in accordance with aspects of the present invention.

FIGS. 6A-6G illustrate features of the endcap assembly of FIGS. 4A-4B.

FIGS. 7A-7H illustrate an endcap and forearm assembly.

FIGS. 8A-8H illustrate an endcap and forearm assembly in accordance with aspects of the present invention.

FIG. 9 illustrates features of the endcap device shown in FIGS. 8A-8H.

FIGS. 10A-10H illustrates additional features of the endcap device shown in FIGS. 8A-8H.

FIGS. 11A-11F illustrate an extension arm system in accordance with aspects of the present invention.

FIGS. 12A-12C illustrate features of the extension arm system of FIGS. 11A-11F.

FIGS. 13A-13C illustrate additional features of the extension arm system of FIGS. 11A-11F.

FIGS. 14A-14E illustrate further features of the extension arm system of FIGS. 11A-11F.

### DETAILED DESCRIPTION

The aspects, features and advantages of the present invention will be appreciated when considered with reference to the following description of preferred embodiments and accompanying figures. In describing the preferred embodiments of the invention illustrated in the figures, specific terminology will be used for the sake of clarity. However, the invention is not intended to be limited to the specific terms so selected, and it is to be understood that each term selected includes all technical equivalents that operate in a similar manner to accomplish a similar purpose. The drawings are not to scale. Any dimensions in the drawings, which are in inches, are merely exemplary.

As discussed above, the endcaps of an extension arm may be placed under heavy loads and stresses, especially when the extension arm is supporting a heavy user device, such as a large screen display. In this type of situation, the shaft of the endcap may bear the bulk of the load. In fact, it has been discovered that the shaft can be a critical failure point in the system. Thus, it is very important to ensure that the shaft can support expected loads.

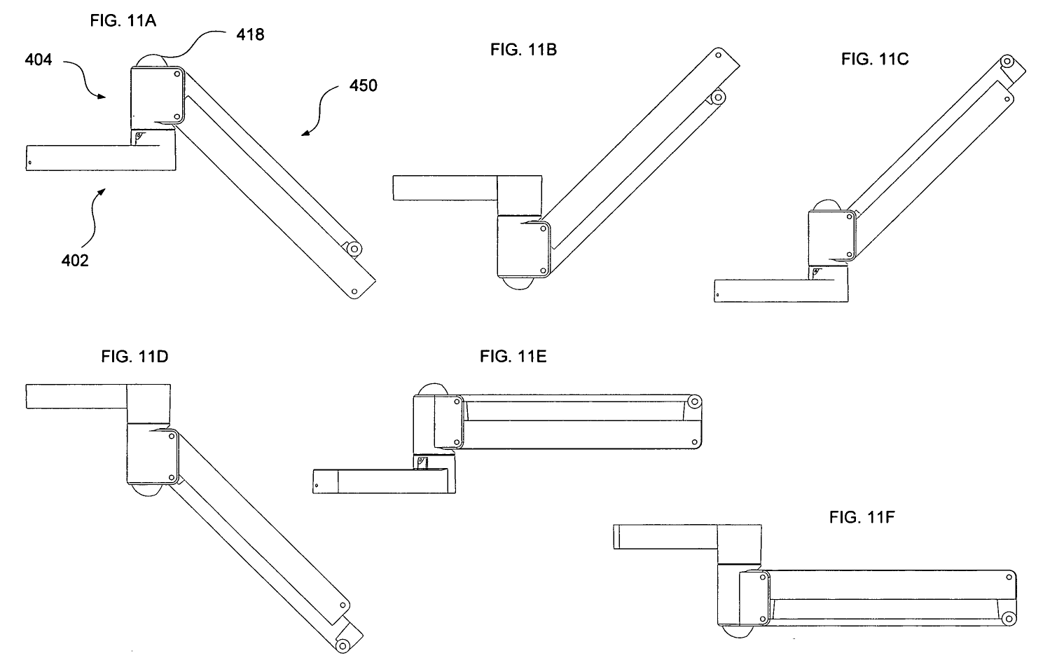

In the past, endcap shafts have included configurations such as that shown U.S. Patent Publication No. 2006/0006297, entitled “Arm Apparatus with Reinforcement,” which illustrates the use of a cruciform-shaped endcap shaft. The 2006/0006297 patent publication, which is commonly assigned to the assignee of the present invention, is expressly incorporated by reference herein. FIGS. 11A, 11C, 11D and 11F of the 2006/0006297 patent publication illustrate an endcap having a cruciform-shaped shaft 154 having an “X” or cross-shaped cross section. See, for example, FIG. 11F therein. As stated in paragraph 0071 of the patent publication, “Portions of the shaft 154 may have an X or cross shape 196, as seen in section C-C of FIG. 11(f). The cross shape 196 is especially desirable when the endcap 102 and/or the endcap 108 are formed using a casting process. The cross shape 196 promotes uniform wall thickness and a lower cost of materials.”

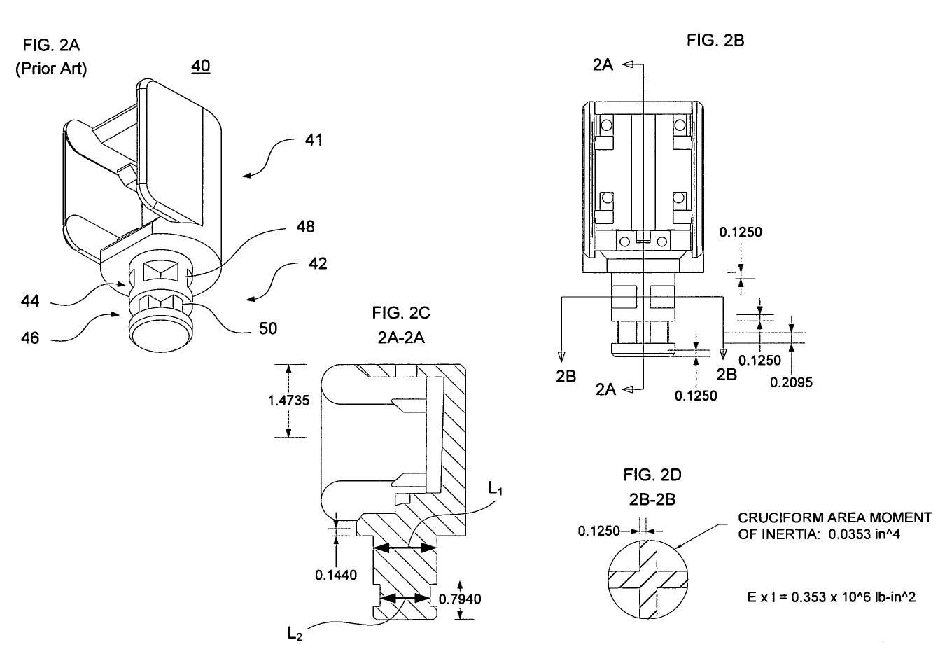

Another known endcap shaft configuration is shown in FIGS. 2A-2B of the instant application. As shown here, endcap 40 includes a main body 41 and a shaft 42, both made of aluminum. The shaft 42 includes an upper shaft section 44 and a lower shaft section 46. FIG. 2C is a longitudinal cutaway view along the 2A-2A axis of FIG. 2B. And FIG. 2D is a transverse cutaway view along the 2B-2B axis of FIG. 2B.

In the endcap 40 of FIGS. 2A-2D, the entire endcap 40 is formed as an integral one-piece unit of cast aluminum. Upper cruciform members 48 have a larger overall length L₁ than lower cruciform member 50, which have an overall length L₂, as seen in FIG. 2C. This is different than the upper and lower cruciform members shown in FIG. 11A of the 2006/0006297 patent publication. In that case, the upper and lower cruciform members are shown having generally the same overall lengths.

A critical point of failure of the extension arm is the junction between the upper shaft section 44 and the main body 41. Extending the length of the upper cruciform members 48 helps to reduce failure at this point. The inventor of the instant application has discovered several highly beneficial ways of improving endcap shaft design to increase the overall strength and stability of the endcap.

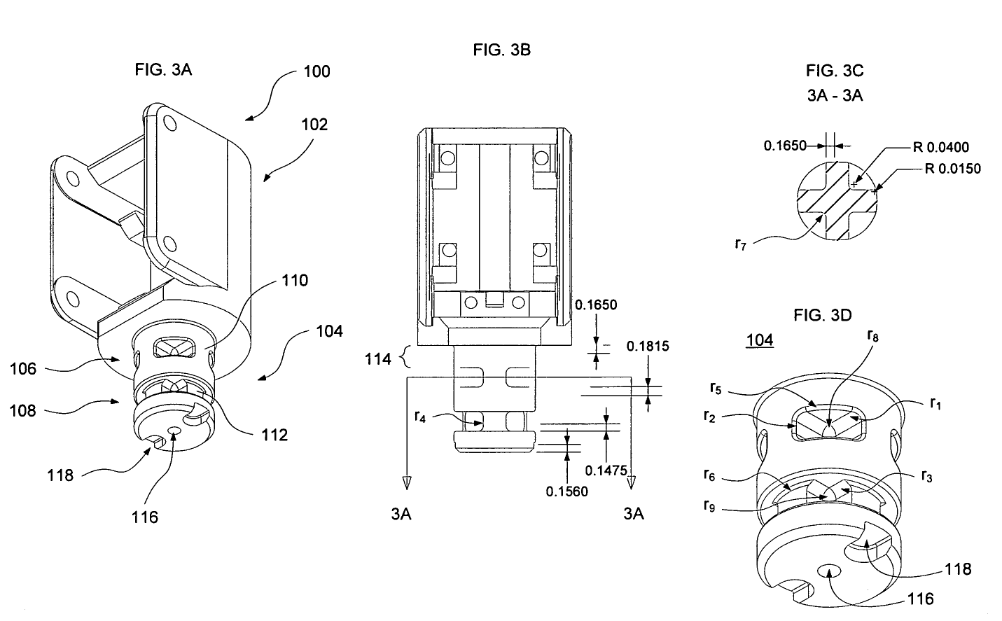

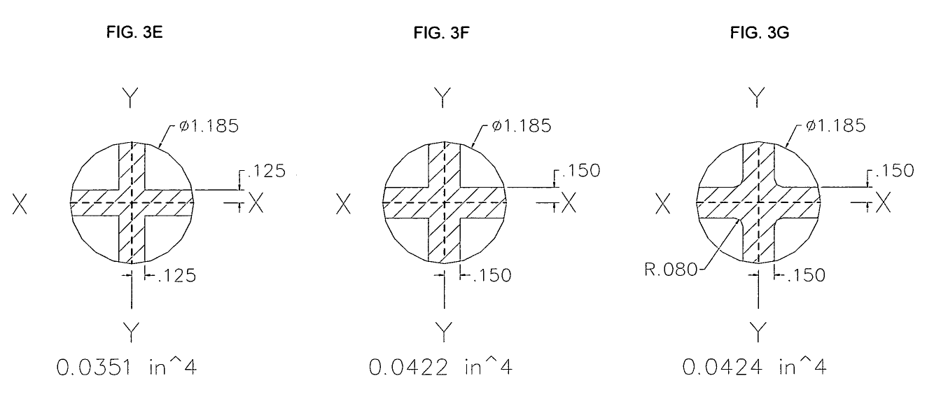

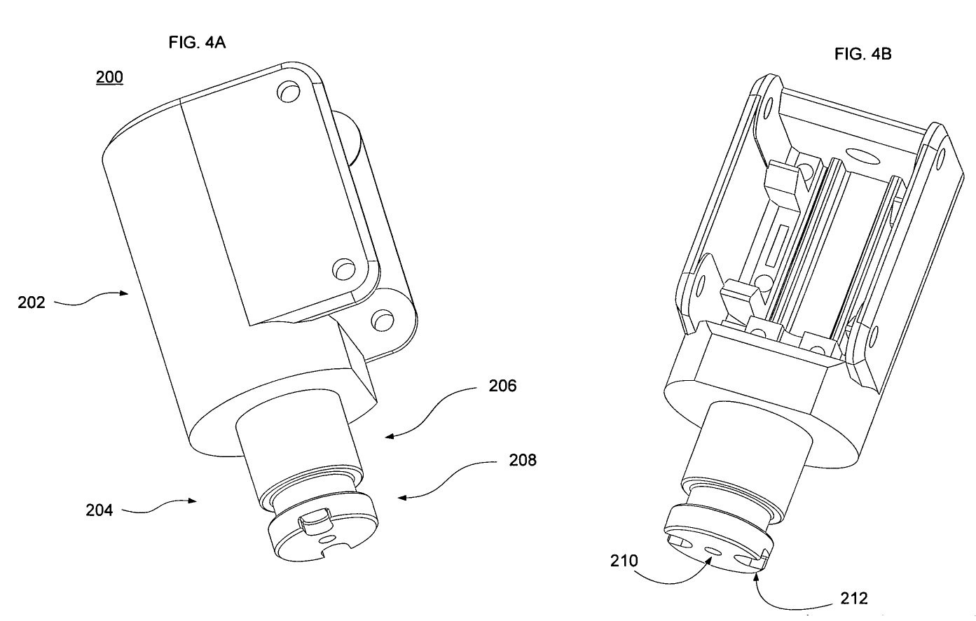

FIG. 3A is a perspective view of an endcap 100 according to one preferred embodiment of the present invention. As shown, the endcap 100 includes a main body 102 and a shaft 104. The shaft 104 has an upper shaft section 106 and a lower shaft section 108. Similar to the aforementioned endcap 40, the endcap 100 is formed as an integral one-piece unit of, for example, cast aluminum. However, other metals or materials such as high strength plastics may be employed. FIG. 3D is an enlarged view of the shaft 104.

As seen in the perspective view of FIG. 3A, the front view of FIG. 3B and the cutaway view of FIG. 3C along the 3A-3A line of FIG. 3B, all corners and edges of upper cruciform members 110 and lower cruciform members 112 should be fully radiused to avoid right angles or other sharp edges. Referring back to FIG. 2D of the instant application and FIG. 11F of the 2006/0006297 patent publication, it can be seen that the cruciform member in those figures contain right angle corners. The right angle configuration may be undesirable from a manufacturing standpoint. A substantial improvement can be obtained through the use of radii on the cruciform members 110 and 112.

Returning to FIGS. 3A-3D, numerous radii r₁, r₂, . . . , r₉ are illustrated. Such radii reduce stress concentrations that would otherwise occur at sharp corners. Furthermore, the radii are extremely beneficial in the one-piece casting process. For instance, the smooth corners of the radii have a lower surface tension, which reduces adhesion of liquid water-based mold release. Should unwanted water be present in the mold during critical points of fabrication, particularly during metal injection, it can flash to steam, resulting in porosity and improper molding of the shaft. The use of radiused upper and lower cruciform members dramatically reduces the chances of water adhesion in the mold, thereby substantially eliminating the steam flashing. The radii also reduce stress concentrations along the shaft and increase the moment of inertia of the shaft.

It is also desirable to increase the width of the cruciform members 110 and 112. For instance, while the width of the upper cruciform member 48 of FIG. 2B may be on the order of 0.25 inches, the width of the upper cruciform member 110 is preferably on the order of 0.3 to 0.5 inches, such as about 0.4 inches.

One result of these changes is to increase the area moment of inertia of the cruciform configuration. The moment of inertia is a property of a beam or other component that defines how well the material in the component resists stress. Beams tend to bend and resist stress about planes as defined by neutral axes. The axes go through the geometric center of symmetrical beams. Placing material as far as possible from the neutral axes produces a high moment of inertia and makes the beam stiff and strong. The moment of inertia is a square function of the distance from a neutral axis. Thus, doubling the distance from the neutral axis increases the moment of inertia by a factor of four. This permits a significant increase in beam strength and stiffness with small changes to the size of the beam.

Typically, the moment of inertia is calculated about two perpendicular neutral axes. For instance, FIGS. 3E, 3F and 3G illustrate three different shaft members, each of which is symmetrical about the respective X-X and Y-Y axes. Thus, for a given shaft member, the moment of inertia Iₓₓ about the X-X axis is the same as the moment of inertia I_{yy} about the Y-Y axis.

The example of FIG. 3E is similar to the shaft of FIG. 2D. In the FIG. 3E example, the shaft is 1 inch in diameter and the cruciform arms each have a thickness of 0.25 inches, which are shown by the X and Y half measurements of 0.125. This results in a calculated moment of inertia of 0.0351 in⁴. In contrast, the example of FIG. 3F shows a preferred example in which the cruciform arms each have a thickness on the order of 0.3 inches, which are shown by the X and Y half measurements of 0.150 inches. The calculated moment of inertia for this example is 0.0422 in⁴. In the alternative preferred example of FIG. 3G, the cruciform arms maintain the thickness of about 0.3 inches and also employ radiused corners. The radii are preferably between 0.05 inches and 0.15 inches, more preferably on the order of 0.08 inches as shown. The moment of inertia in this case is calculated to be 0.0424 in⁴.

Of course, it should be understood that the dimensions in these and other examples throughout the specification are exemplary of the invention and variations in system specifications or manufacturing requirements may change particular dimensions. Thus, while an example may be given wherein the shaft is 1 inch in diameter, the cruciform arms are 0.3 inches in thickness, and radii of about 0.08 inches are used (or no radii at all), such parameters can be scaled up or down in size accordingly. For instance, if the shaft is reduced to 0.5 inches, the cruciform arms would desirably be reduced to 0.150 inches in thickness, and the radii would desirably be on the order of 0.04 inches or between about 0.25 and 0.75 inches (or no radii at all). Thus, in this instance, there would be a 1:1 scaling (either upward or downward) of the various component dimensions.

Of course, some minor variations in the relative scaling of different components may be expected; this is particularly true when material durability is taken into account. Thus in the 0.5 inch shaft diameter example, steel or an even more durable material may be required. This, in turn, may affect the requirements for moment of inertia. Therefore, it may be that the cruciform arms are chosen to have a thickness from a range of 0.15 to 0.25 or greater, and the radii may be chosen to be on the order of 0.04 to 0.07 or greater. Alternatively, more durable materials may relax the moment of inertia requirement, and thus the cruciform arm thickness may be chosen from the range of 0.085 to 0.15 or less and the radii may be chosen to be on the order of 0.02 to 0.04 or less (or no radii at all).

It is also preferable to increase the thickness of portions of the upper shaft section 106, for example top region 114 (see FIG. 3B). It has been discovered that the maximum stress point of the shaft 104 is at top region 114. By increasing the thickness of top region 114, the shaft 102 is better able to handle an applied stress. While the exact thickness of the top region 114 will vary depending on the size of the endcap 100, in the illustrated embodiment the top region 114 preferably has a thickness of at least 0.15 inches, for example on the order of 0.2 to 0.3 inches or more.

Overall, the shaft 104 has an increased moment of inertia for the cruciform sections, as well as increased tensile and shear areas. And the radiused corners reduce water adhesion during the molding process. These critical features result in a substantially improved shaft configuration. This is particularly beneficial when the shaft 104 is integrally molded as a one-piece unit with the main body 102 of the endcap 100.

The shaft 104 may also include a receptacle 116 and a pair of recesses 118 along a bottom region 120 thereof. The receptacle 116 and the pair of recesses 118 may be utilized as part of an anti-loosening mechanism at the connection between the shaft 104 and a mounting assembly or other device (not shown), such as is described more fully in U.S. Patent Publication No. 2006/0266903, entitled “Tapered Mini Arm Having an Anti-Loosening Mechanism,” which is assigned to the assignee of the present invention and is hereby incorporated by reference herein.

In another preferred embodiment of the present invention, the shaft and the main body of the endcap are formed of different materials while both are cast as a single component. FIGS. 4A and 4B illustrate endcap 200, which includes a main body 202 and a shaft 204. Here, the main body 202 is preferably aluminum, and the shaft 204 is preferably steel such as wrought steel. The wrought steel is desirably fabricated by machining the metal into a predetermined shape.

The shaft 204 includes an upper section 206 and a lower section 208. Unlike the cruciform shaft 104 described above, neither section 206 nor section 208 has a cruciform configuration. While sections 206 and 208 may be of different diameters, both are preferably substantially cylindrical. The shaft 204, as with the shaft 104, may include a receptacle 210 and a pair of recesses 212 along a bottom region 120 thereof. The receptacle 210 and the pair of recesses 212 may be utilized as part of an anti-loosening mechanism at the connection between the shaft 204 and a mounting assembly or other device (not shown).

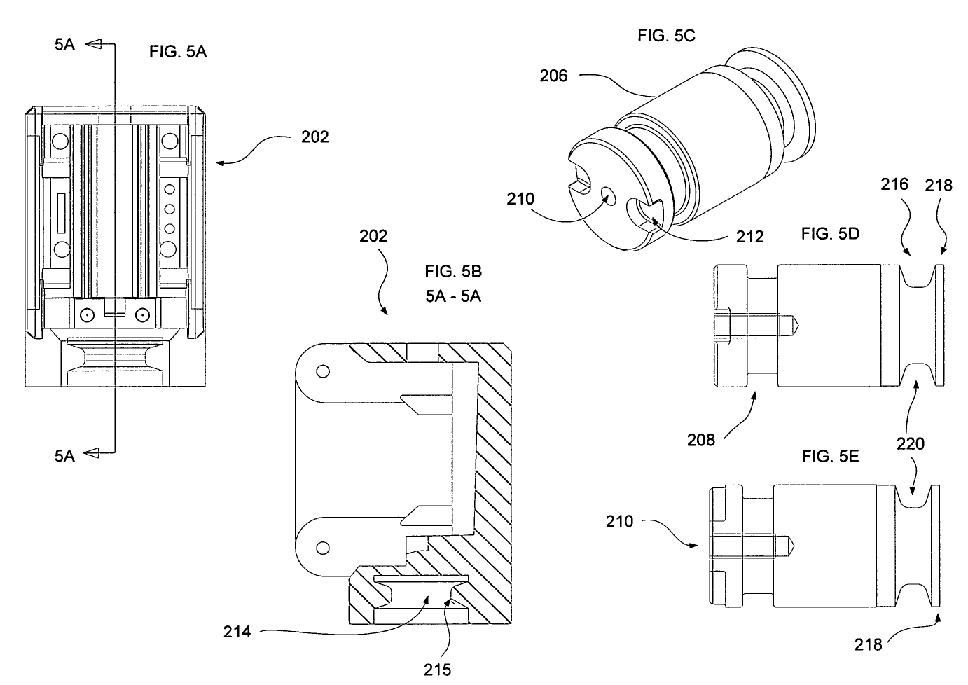

FIG. 5A is a front view of the main body 202, and FIG. 5B is a cutaway view of the main body 202 taken along the 5A-5A line of FIG. 5A. As shown, the main body 202 includes a receptacle 214 in which a portion of the shaft 204 is disposed. A generally annular protrusion 215 is preferably part of the receptacle 214. FIGS. 5C-5E are views showing the shaft 204 in more detail. As best seen in the side views of FIGS. 5D and 5E, the shaft 204 includes a connection region 216 at one end thereof. When the endcap 200 is cast, for example by pouring molten aluminum or other metal into a mold that holds the pre-fabricated shaft 204, the connection region 216 of the shaft 204 is securely received by the receptacle 214 of the main body 202.

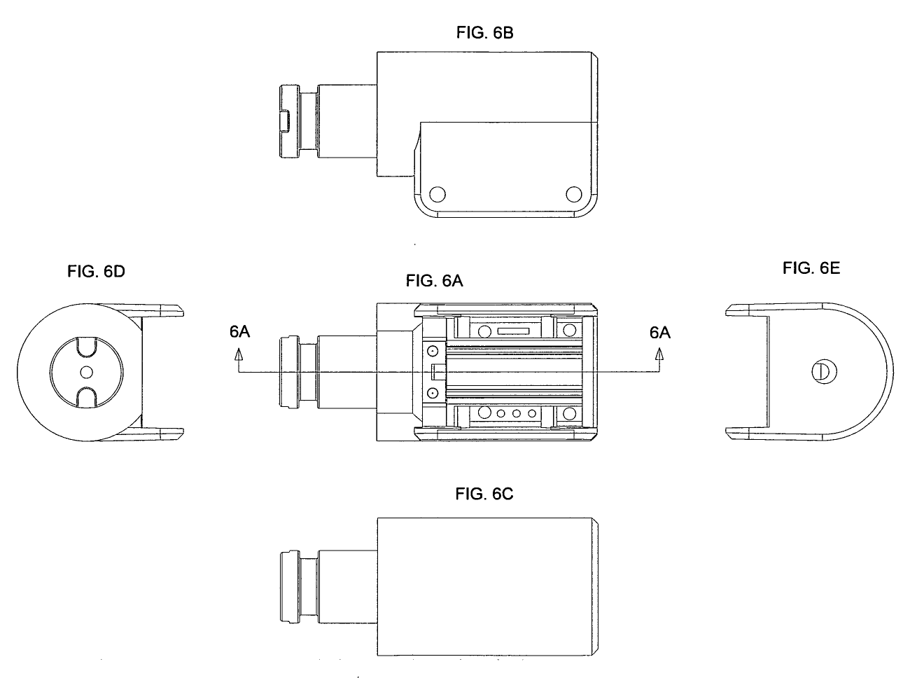

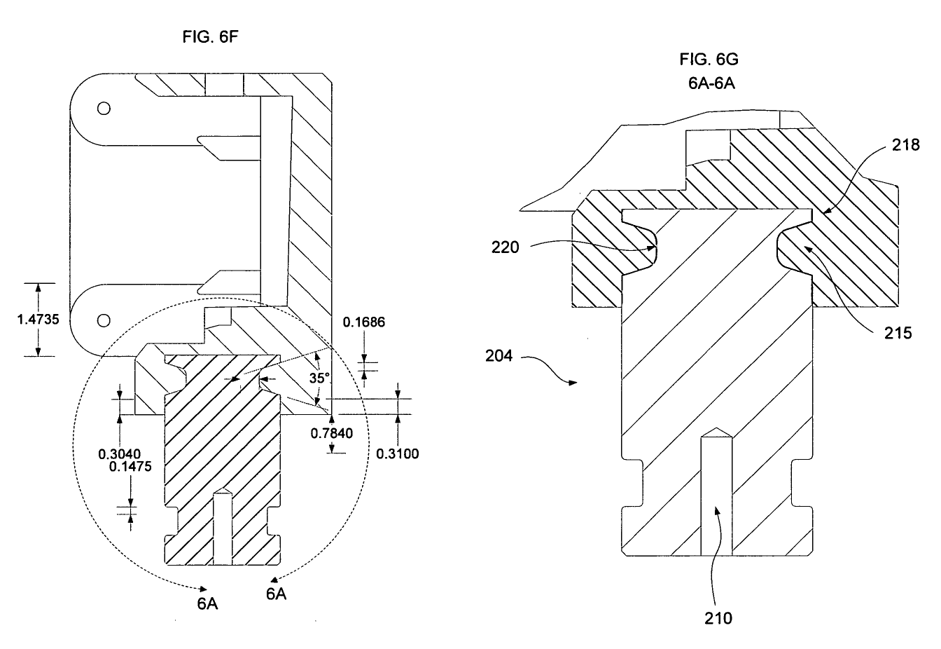

FIGS. 6A-6E illustrate the endcap 200 after the main body 202 is cast about the shaft 204. Specifically, FIG. 6A is a front view of the endcap 200, FIG. 6B is a right hand side view, with the left hand side view being a mirror image thereof, FIG. 6C is a rear view, FIG. 6D is a bottom view, and FIG. 6E is a top view. FIG. 6F is a cutaway view of the endcap 200 taken along the 6A-6A line of FIG. 6A. And FIG. 6G is an enlarged view showing the connectivity between the shaft 204 and the main body 202. As shown in FIG. 6G, the generally annular protrusion 215 of the receptacle 214 helps secure the main body 202 to the connection region 216 of the shaft 204. The protrusion 215 is formed as part of the casting process, for example when molten metal such as aluminum is poured in a mold that includes the pre-fabricated shaft 204. The shaft 204 may be, by way of example only, fabricated by machining a wrought steel rod to the specified dimensions.

As can be seen in FIGS. 5D-5E and 6F-6G, the connection region 216 has a recessed area 220 which is preferably formed as part of the pre-fabrication process for the shaft 204. The recessed area 220 desirably has a generally annular configuration which includes radiused or rounded edges. These radii, along with the fact that upper section 206 and lower section 208 are formed generally cylindrically, promote better flow of material in the mold when the body 204 is cast. This aides part filling and reduces porosity. As shown in the exemplary view of FIG. 5B, annular portion 215 of the receptacle 214 is preferably cast with a radiused/rounded edge. The radiused/rounded annular portion 215 of the receptacle 214 is preferably cast at an angle of at least 15-20°. More preferably, the angle is at least 30°, such as about 35°, as shown in FIG. 6F. The combination of the pre-machined recessed area 220 and the cast annular protrusion 215 is substantially better than previous knurling configurations, as there is more area and more direct mechanical locking between the shaft and body components. This results in a stronger endcap 200.

As discussed above, the shaft 204 is preferably steel, such as wrought steel. The mechanical properties of wrought steel are more desirable for use as the shaft 204 than the mechanical properties of aluminum. Wrought steel will also consistently produce a stronger, stiffer part with a greater safety factor than the same part made with aluminum. The wrought steel is preferably machined to the desired shape before being coupled to the mold for casting of the endcap main body 202.

The configuration of the present embodiment provides a greatly increased moment of inertia over the length of the shaft as compared to shaft 42 of FIGS. 2A-2D. The cruciform example shown in FIG. 2D has an area moment of inertia of approximately 0.035 in⁴. The moment of inertia for the shaft 204 is on the order of 0.0966 in⁴, which is a factor of about 2.76 times greater than for the FIG. 2D cruciform. In addition, Young's Modulus for the shaft 204 is approximately three times greater than Young's Modulus for the shaft 42. The combination of moment of inertia and Young's Modulus make the shaft 204 more than 8 times stiffer than the shaft 42, with a stiffness of about 2.9×10⁶ lb-in² as compared to a stiffness of about 0.353×10⁶ lb-in². While this factor of 8 times the stiffness of the shaft 42 is a substantial advancement, even a much lower factor of 4 times the stiffness of the shaft 42 (e.g., 1.45×10⁶ lb-in²) results in a superior product. Furthermore, the use of wrought steel increases the tensile and shear area over the length of the shaft. Thus, the shaft 204 is a substantial improvement over the shaft 42.

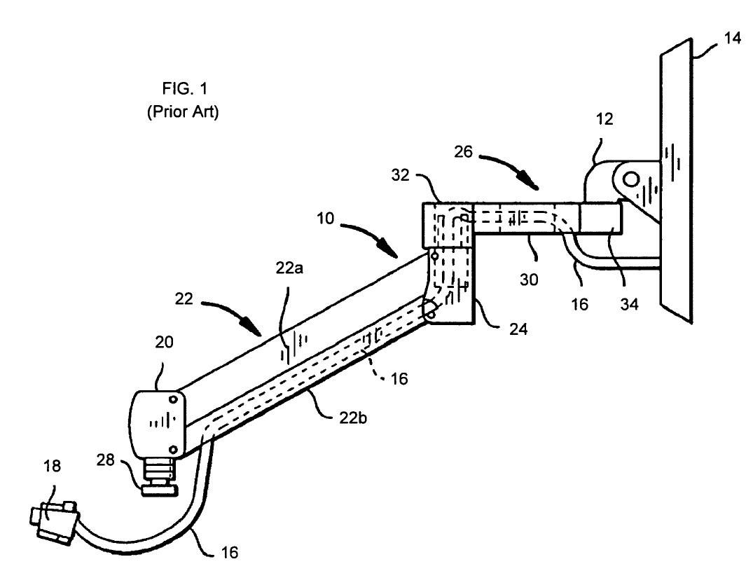

The endcaps 100 and 200 are preferred embodiments of endcaps that are particularly beneficial when used to couple one end of an extension arm to a mounting assembly, which in turn secures the extension arm to a desk, wall, ceiling or other location. Referring back to FIG. 1, it can also be seen that the endcap 24 couples a second end of the arm 22 to the forearm extension 26. While the shafts 104 and 204 of the present invention may be used to couple an endcap to the forearm extension, it is desirable in some situations to use a different type of endcap configuration. By way of example only, some aesthetically pleasing extension arm assemblies include cable management. For such configurations, cables of the user device (e.g., flat panel display), are hidden within the forearm extension and in the arm itself. In order to achieve this, a cruciform shaft or solid shaft cannot be employed, as there would not be a way of internally passing the cable through the forearm extension and into the arm with those types of shafts. Thus, a hollow or open shaft configuration is needed.

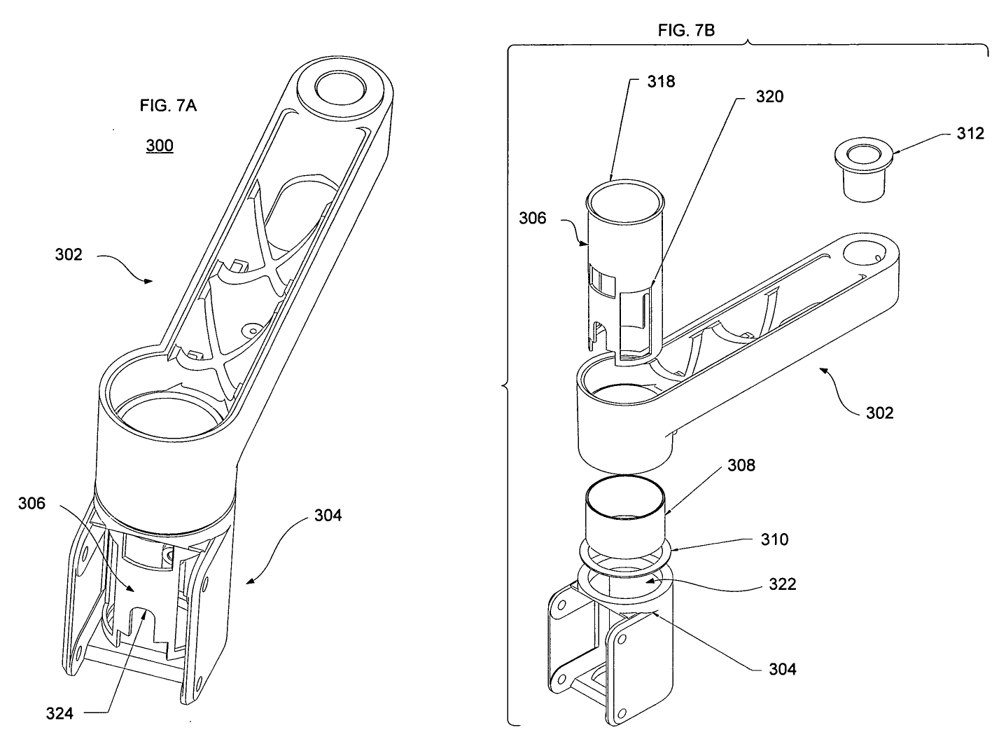

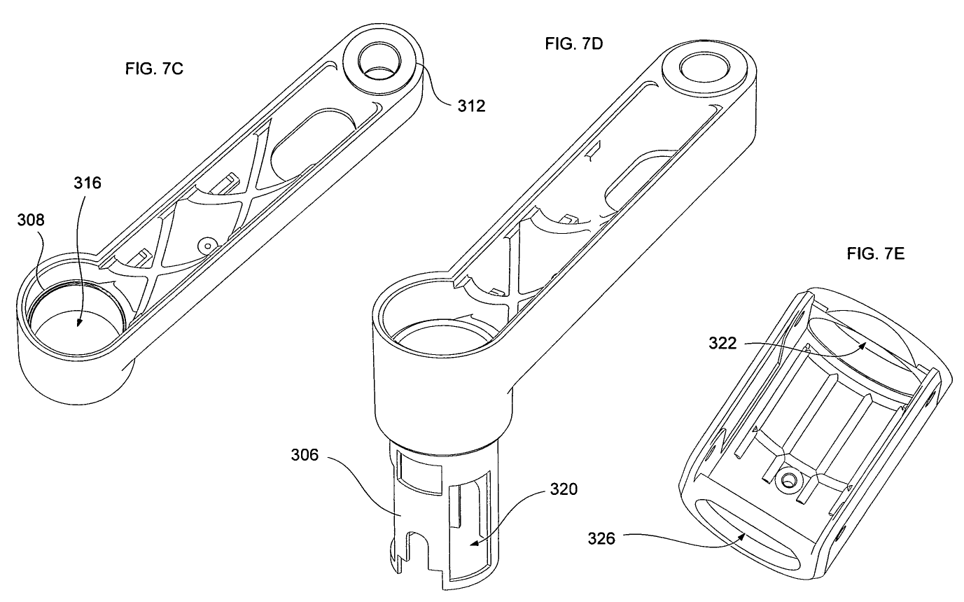

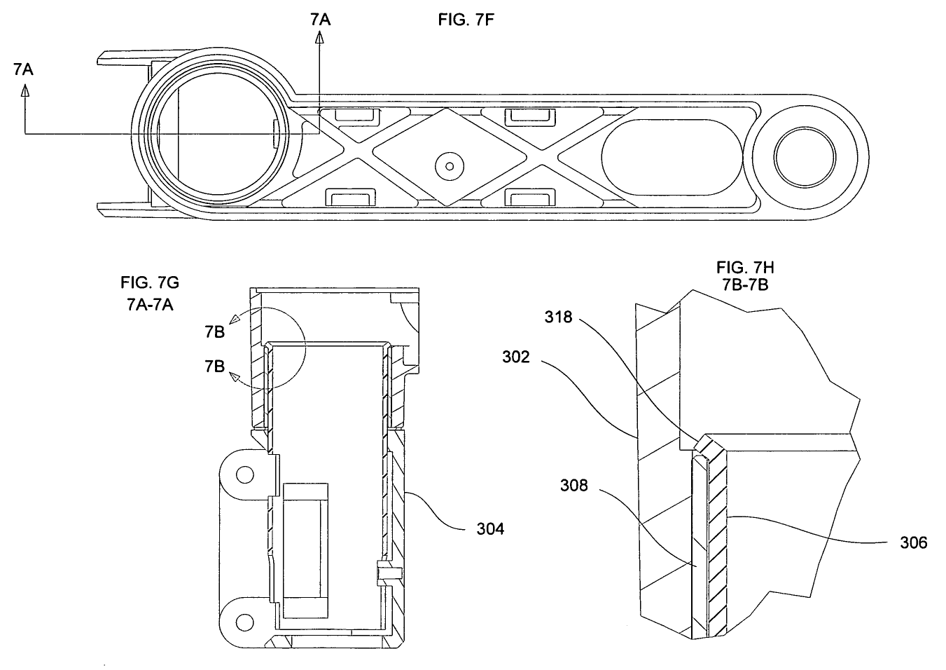

FIG. 7A illustrates an endcap and forearm assembly 300 suitable for cable management, which is assembled according to a gluing process. As shown in the exploded view of FIG. 7B, the assembly 300 includes a forearm extension 302, an endcap body 304, a hollow pivot tube 306, a first bushing 308, a washer 310 and a second bushing 312. The second bushing 312 is used when coupling a tilter apparatus such as tilting device 12 (see FIG. 1) to the forearm extension 302.

The process of fabricating the assembly 300 will now be described. The forearm extension 302 is illustrated in FIG. 7C with the second bushing 312 secured in a receptacle 314 at a first end of the forearm extension 302. As seen in this figure, the forearm extension 302 includes an opening 316 at the other end of the forearm extension 302. The first bushing 308, which is preferably a bronze bushing, is press fit into the opening 316. While the use of bronze is preferred, other suitable materials may also be used for the first bushing 208. Alternatively, the first bushing 208 may be omitted entirely.

Next, the pivot tube 306 is secured to the forearm extension 302. As shown in FIG. 7B, the pivot tube 306 includes a lip 318 at a top edge thereof. One or more windows 320 are provided at various points along the sidewall of the tube 306. In preparation for the connection with the forearm extension 302, grease is applied to the outer upper end of the tube 306 near the lip 318. Then the tube 306 is inserted into the opening 316 of the forearm extension 302. After insertion, the exposed lower end of the tube 306 is de-greased. The washer 310 is also slipped on the lower end of the tube 306, resulting in the partial assembly as shown in FIG. 7D.

The endcap 304 is shown in FIG. 7E. Epoxy or other glue is applied in a specified bead pattern to interior points of the endcap 304. Once the epoxy is applied, the tube 306 is inserted into opening 322 of the endcap. Here, the axial clearance between all components is set and the assembly 300 is left alone so that the glue cures. The curing process takes approximately 6 hours. At the end of the curing process, any additional components such as washers and screws are secured to the assembly 300. Screws may be tightened through access hole 324. The finished product can be used to provide cable management, with the cable(s) being run through the length of the forearm extension 302, through the hollow tube 306, and out of hole 326 at the end of the endcap 304 opposite the forearm extension 302.

FIG. 7F is a top down view of the assembly 300. FIG. 7G is a cutaway view along the 7A-7A line of FIG. 7F, and FIG. 7H is an enlarged view of region 7B-7B from FIG. 7G. Manufacturing limitations prevent a square edge shape for the tube 306, in particular the formation of the lip 318. Thus, as seen in the cutaway and enlarged views, the lip 318 is formed on an angle. Because of this, it is not easy to make the lip 318 abut the aluminum or other metal of the forearm extension 302; rather, the lip 318 bares on the bushing 308. This causes a thrust load to be applied to the bushing 308 rather than the casting of the tube 306.

While the aforementioned assembly process has been used successfully, it has certain disadvantages that make it undesirable in some situations. For instance, thrust loads go through the friction interference fit between the bushing and the tube casting. As noted above, it is disadvantageous to have the thrust load applied to the bushing 308. Also, the assembly process, including curing, takes a long time and delays fabrication of the finished product. The gluing operation cure time does not allow for one-piece manufacturing flow. Rather, manufacturing of the components must be done in batches.

Furthermore, epoxy and other glues are high-tack, very messy substances that must be kept off of all surfaces except for those specified. In addition, the assembly operation requires a gluing process that has clean part surfaces, greased part surfaces, and glued surfaced. These different types of prepared surfaces must be isolated from each other to prevent the product from being unusable and ruined. Glue technology requires strict process controls to assure strong, safe joints. There is no non-destructive post-assembly test to verify joint integrity. If the gluing is performed improperly, it may not be apparent post-assembly. Thus, a poorly glued part may be used in a final product, leaving the potential for failure of the product. This is a very undesirable situation.

Thus, applicant has developed a new endcap and forearm assembly 400 suitable for cable management, but which is assembled without the time consuming and difficult gluing process.

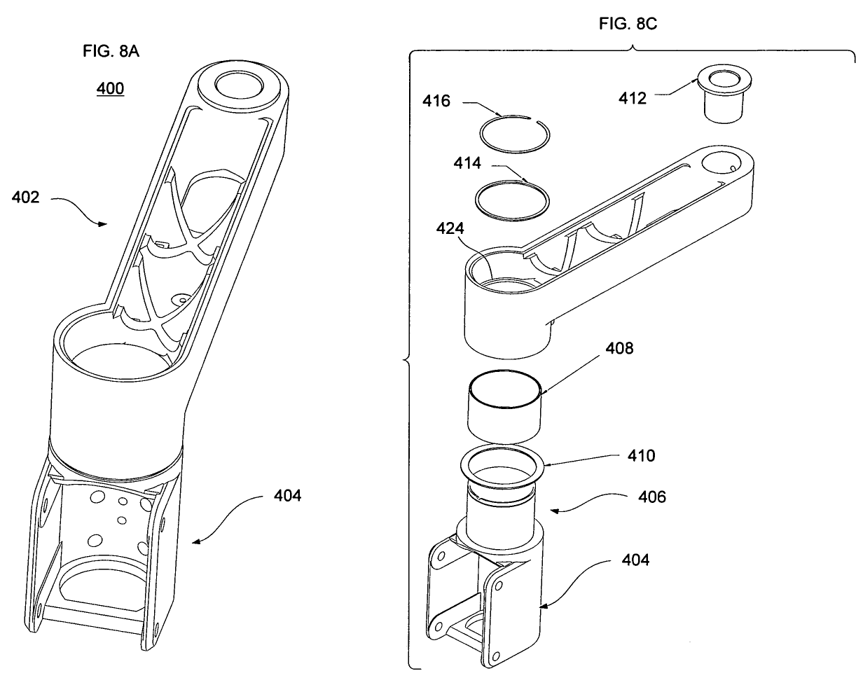

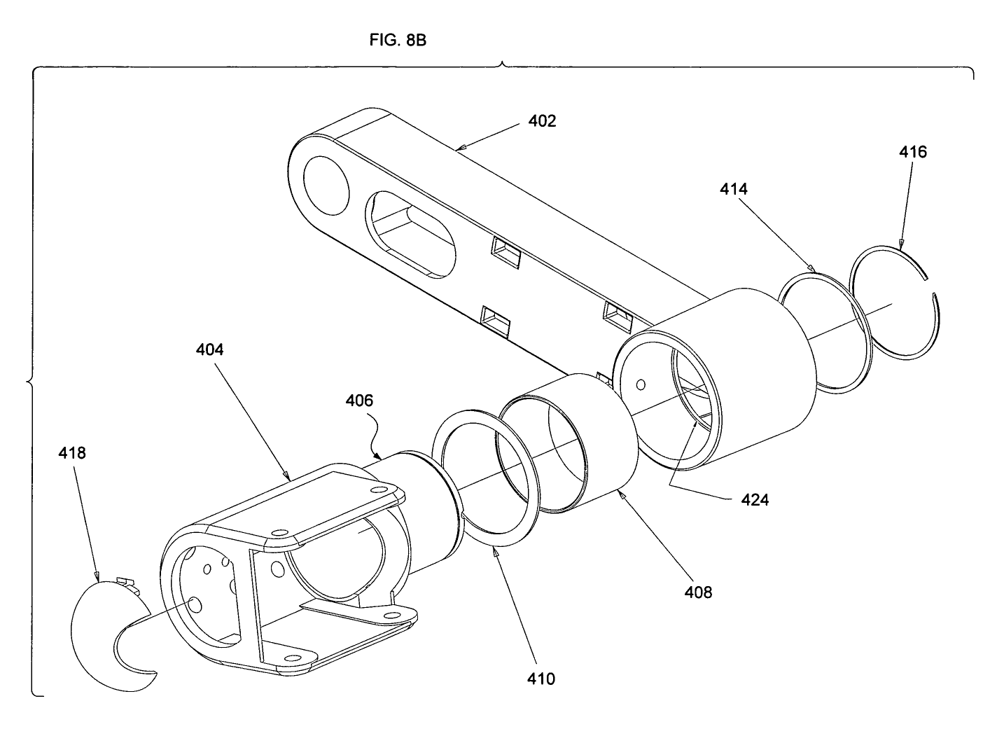

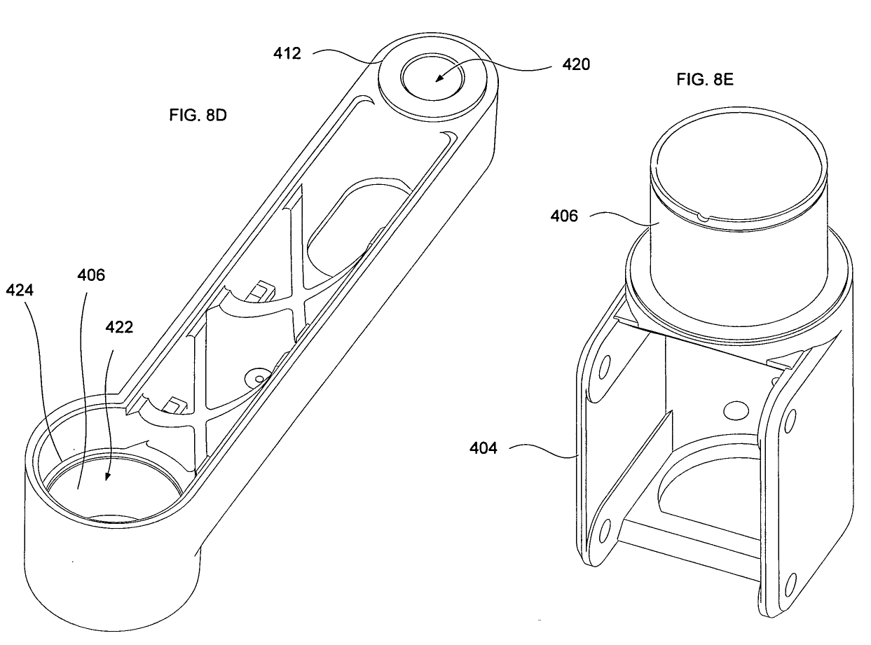

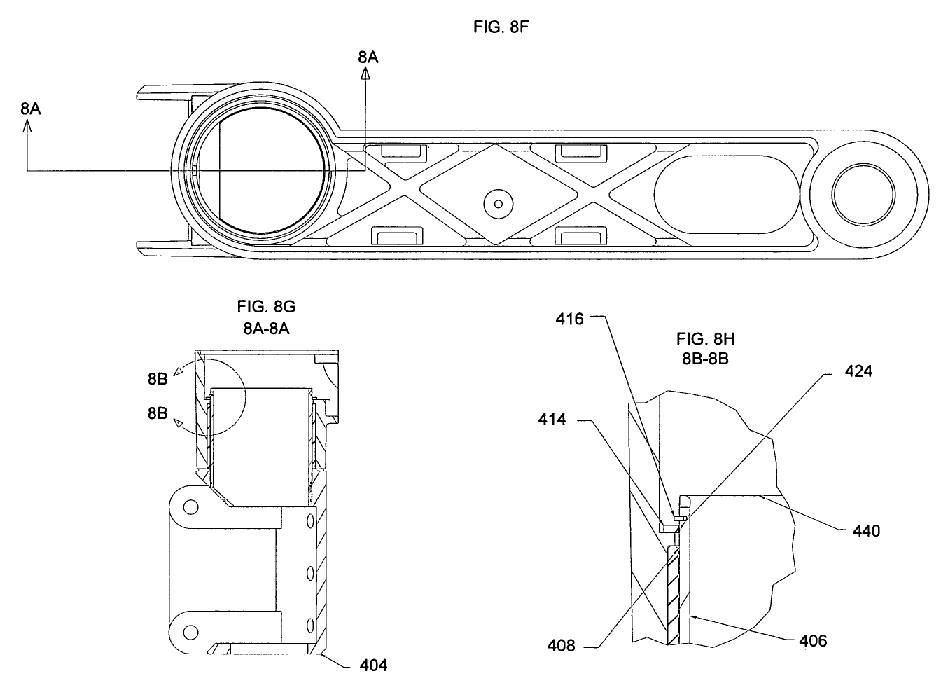

FIG. 8A illustrates a completed endcap and forearm assembly 400. As shown in the exploded views of FIGS. 8B and 8C, the assembly 400 includes a forearm extension 402, an endcap body 404, an open shaft such as hollow tube 406, a first bushing 408, a washer 410 and a second bushing 412. The assembly 400 also preferably includes a thrust washer 414 and a snap ring 416. As shown in FIG. 8B, a decorative endcap cover 418 may also be employed.

A preferred process of fabricating the assembly 400 will now be described. The forearm extension 402 is illustrated in FIG. 8D with the second bushing 412 secured in a receptacle 420 at a first end of the forearm extension 402. As seen in this figure, the forearm extension 402 includes a bore 422 at the other end of the forearm extension 402. The bore 422 includes a shoulder 424 along the sidewall of the bore. The shoulder 424 is preferably not disposed directly adjacent either end of the bore. Rather, the shoulder 424 is preferably disposed somewhere between the ends of the bore 422, for instance spaced at least 20-25% of the length of the bore 422 from the edges thereof. The first bushing 408, which may be made of bronze, is press fit into the bore 422 until it abuts the shoulder 424, as shown in FIG. 8D.

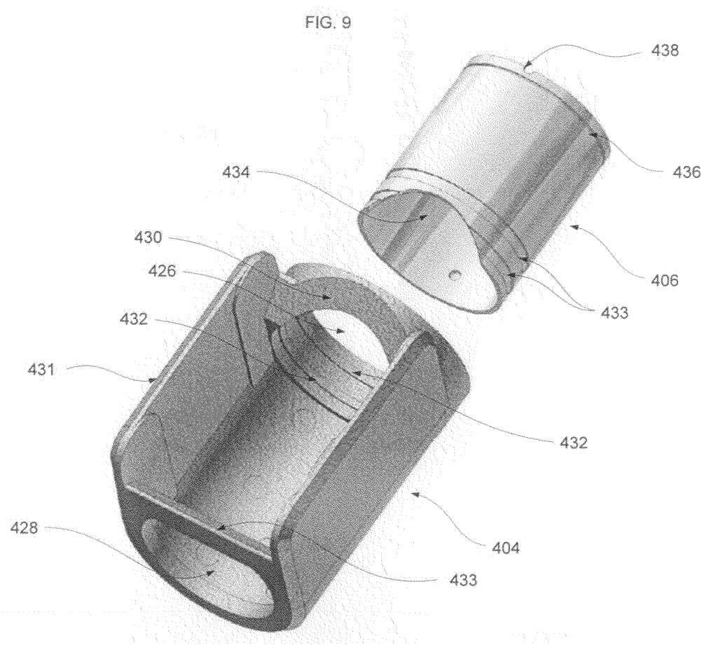

Prior to connection with the forearm assembly 402, the endcap body 404 and the tube 406 are fabricated. FIG. 9 is an idealized representation of the endcap body 404 and the tube 406 as separate components. However, as will be explained below, the endcap body 404 is preferably integrally cast around the tube 406 so that it forms a unitary structure with the tube 406. As seen in FIG. 9, the endcap body 404 includes a first opening 426 at a first end thereof and a second opening 428 at a second end thereof. The first end of the endcap body 404 preferably also includes a bridge section 430 adjacent the first opening 426. The bridge section 430 is preferably curved or arcuate, and connects the upper edges of the generally U-shaped body having sidewalls 431. A lower spanning member 433 preferably also couples the lower edges of the generally U-shaped body. While the endcap body 404 is shown as being generally U-shaped, this is not required. For instance, the body may be generally rectangular and have the sidewalls 431 while being substantially open along one side of the body.

The endcap body 404 desirably also includes one or more generally annular protrusions 432 about the first end which are formed when molten aluminum or other metal is cast around the tube 406. The tube 406 desirably comprises steel, such as wrought steel; however other metals or different materials meeting specified manufacturing requirements may also be used. The endcap body 404 is desirably formed by casting molten aluminum in a mold with the prefabricated tube 406. The molten aluminum flows through the mold and mechanically bonds to generally annular recesses 433, resulting in the protrusions 432 about the first end of the endcap 404. As shown in FIG. 9, the tube 406 preferably includes a “bird mouth” opening 434 at one end of the tube 406 that conforms to the shape of the bridge section 430. Prior to casting, a groove 436 and a notch 438 about the other end of the tube 406. The notch 438 can be used to help orient the parts correctly during fabrication.

Casting the endcap body 404 to the tube 406 avoids the use of (epoxy) glue. The tube 406 can be quickly and easily fabricated. Defects in the casting process are readily detectable, thereby avoiding hidden flaws that may occur with the gluing process. Also, should a defect exist, the endcap body 404 may be melted down and the material re-used, as opposed to the gluing process, thereby minimizing wasted material.

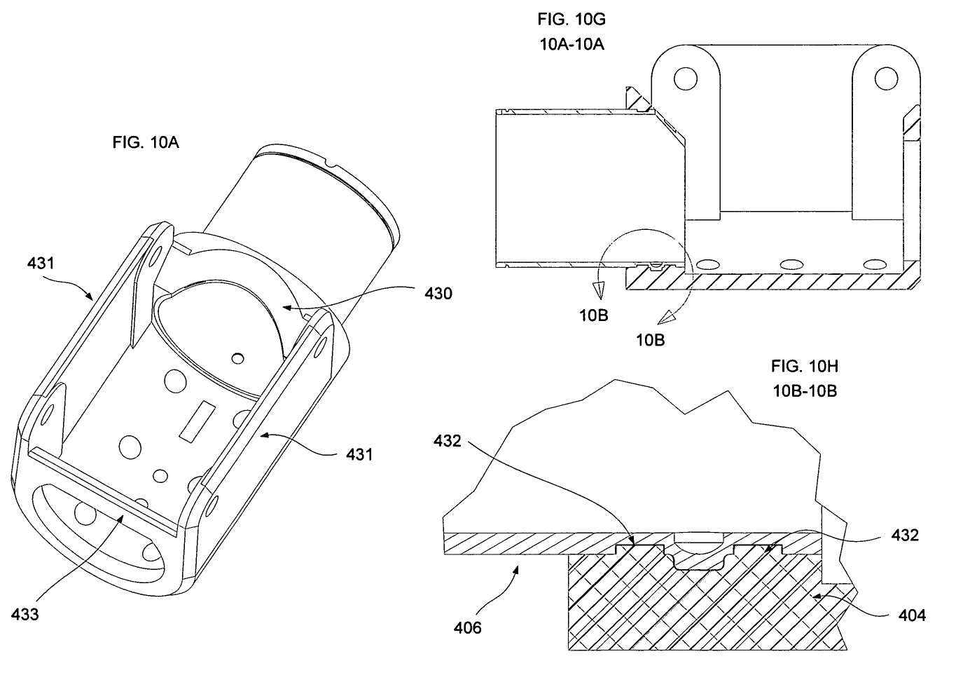

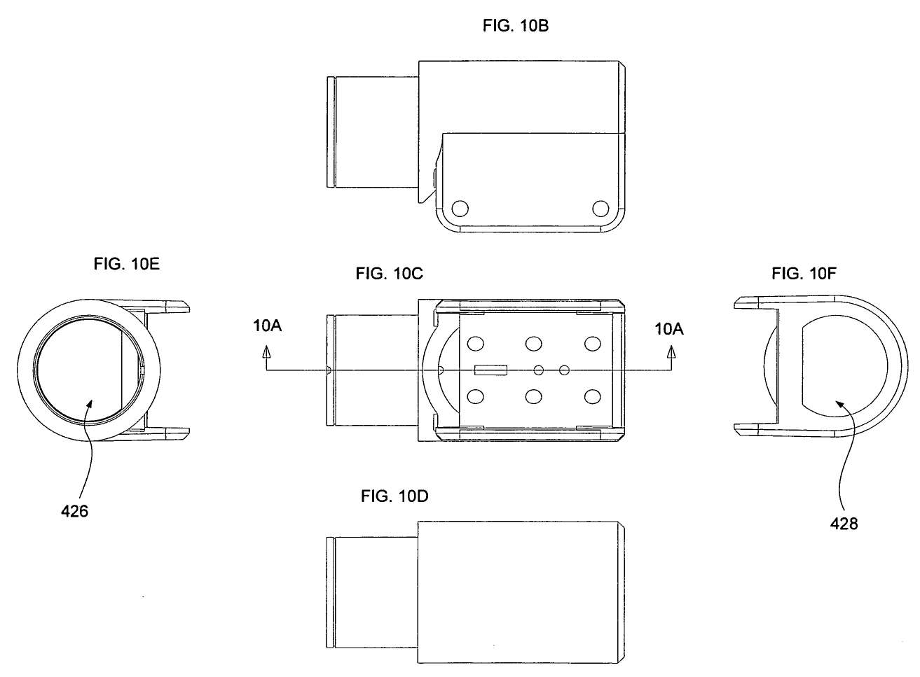

FIGS. 10A-10F illustrate the endcap 404 and tube 406 after the casting process is complete. FIG. 10G is a cutaway view along the 10A-10A line of FIG. 10C, and FIG. 10H is an enlarged view of the 10B-10B region of FIG. 10G showing details of the connection between the tube 406 and the endcap 404. The protrusions 432 of the endcap 404 are evident in FIG. 10H, which shows that the tube 406 mechanically interlocks with the protrusions 432 for a secure and stable connection.

Once the assembly of the tube and endcap is complete, the washer 410 may be inserted around the tube 406 as shown in FIG. 8E. Then the forearm extension 402 is coupled to the tube 406 as shown in FIG. 8A. The thrust washer 414 is then placed about an upper portion of the tube 406. The snap ring 416 may then be applied to the tube 406, for instance by securing the snap ring 416 to the groove 436.

FIG. 8F is a top down view of the assembled device 400. FIG. 8G is a cutaway view taken along the 8A-8A line of FIG. 8F. And FIG. 8H is an enlarged view of the 8B-8B region of FIG. 8G showing details of the assembled tube 406 and the forearm extension 402. As shown, the shoulder or lip 424 provides separation between the bushing 408 and the thrust washer 414. This configuration helps ensure that the thrust load is applied to the tube 406 rather than the bushing 408. Also shown in this figure is radiused or beveled edge 440 of the tube 406. This avoids a sharp corner, which protects wires or cables of the user device that are run internally through the assembly 400.

While the instant example of assembly 400 includes components not required in the assembly 300, such as the thrust washer 414 and the snap ring 416, there are numerous advantages that make the assembly 400 highly beneficial. Because loads are applied to the tube 406 directly rather than through friction fitting of the bushing 408, slippage cannot occur between the bushing and the bore 422 of the forearm extension 402. Also, the casting and other assembly processes here entirely avoid the need for gluing. This saves a substantial amount of time, allowing each assembly 400 to be fabricated at one time, without the need to manufacture particular components in batches. As there is no glue used in the fabrication process, all of the problems associated with gluing are also avoided.

Once the assembly 400 has been fabricated, it can be connected to other components of an extension arm system. FIGS. 11A-11B illustrate examples of the assembly 400 connected to extension arm 450. In the example of FIG. 11A, the assembly 400 is configured with the forearm extension 402 disposed below the endcap 404, while in the example of FIG. 11B, the assembly 400 is configured with the forearm extension 402 disposed above the endcap 404. Either configuration may be used in a variety of situations.

As shown in FIGS. 11A and 11D, the extension arm 450 may be positioned in a “down” orientation regardless of whether the endcap 404 is disposed above or below the forearm extension 402. Similarly, as shown in FIGS. 11B and 11C, the extension arm 450 may be positioned in an “up” orientation regardless of whether the endcap 404 is disposed above or below the forearm extension 402. And as the extension arm 450 may be moved between fully extended up and down positions, it may be placed in a horizontal position as shown in FIGS. 11E and 11F.

The maximum up and down angles are preferably on the order of at least about 45°. This provides an overall range of motion of approximately 90°. The exact range of motion may be slightly less or may be greater. For instance, in certain examples the maximum up or down angle may be more than 45°, such as 55° to 65°, and the maximum overall range is between about 110° to 130°. Such wide ranges are extremely advantageous, as they permits the user to position his or her display or other user device in the most ergonomic positions as desired.

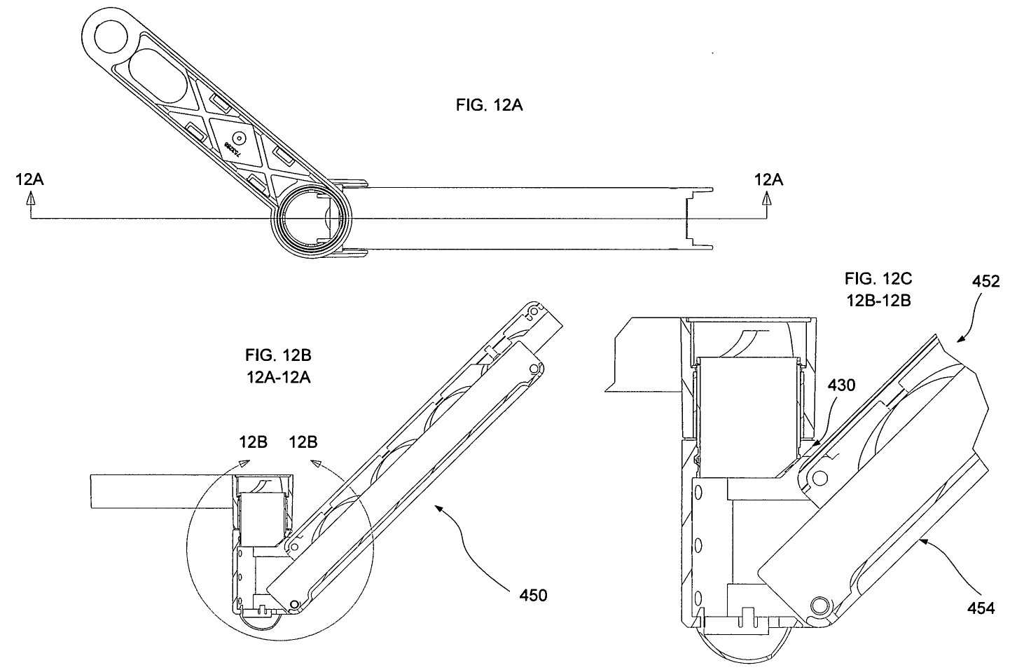

FIG. 12A is a top down view of the configuration shown in FIG. 11B. FIG. 12B is a cutaway view taken along the 12A-12A line of FIG. 12A. And FIG. 12C is an enlarged view of the 12B-12B region of FIG. 12B. As discussed above, the bridge section 430 of the endcap body 404 is preferably curved or arcuate. As shown in FIG. 12C, the bridge section 430 and the “bird mouth” opening 434 enable the extension arm 450 to extend vertically in a fully up orientation without impinging on the endcap 404.

The extension arm 450 includes an upper arm 452 and a lower arm 454. The specific configuration of the extension arm 450, including upper and lower arms 452 and 454, is not critical to the invention of the instant application. Numerous extension arm types may be used. By way of example only, any of the extension arms disclosed in U.S. Patent Publication Nos. 2006/0006297 or 2006/0266903, which are referenced above, may be employed. Regardless of the specific extension arm used, the bridge section 430 provides adequate clearance for the extension arm.

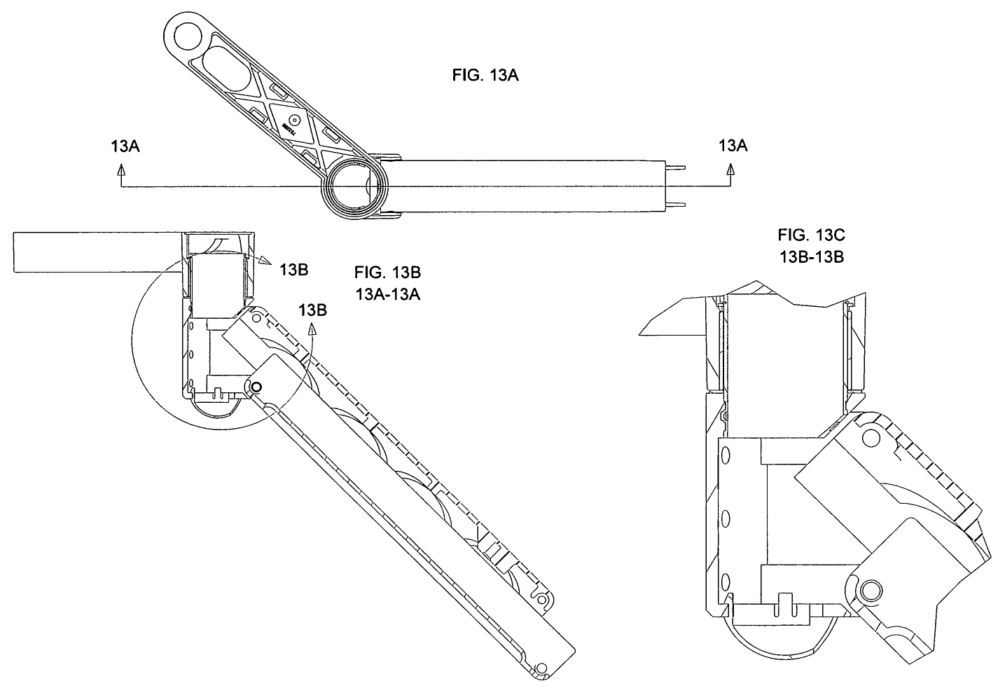

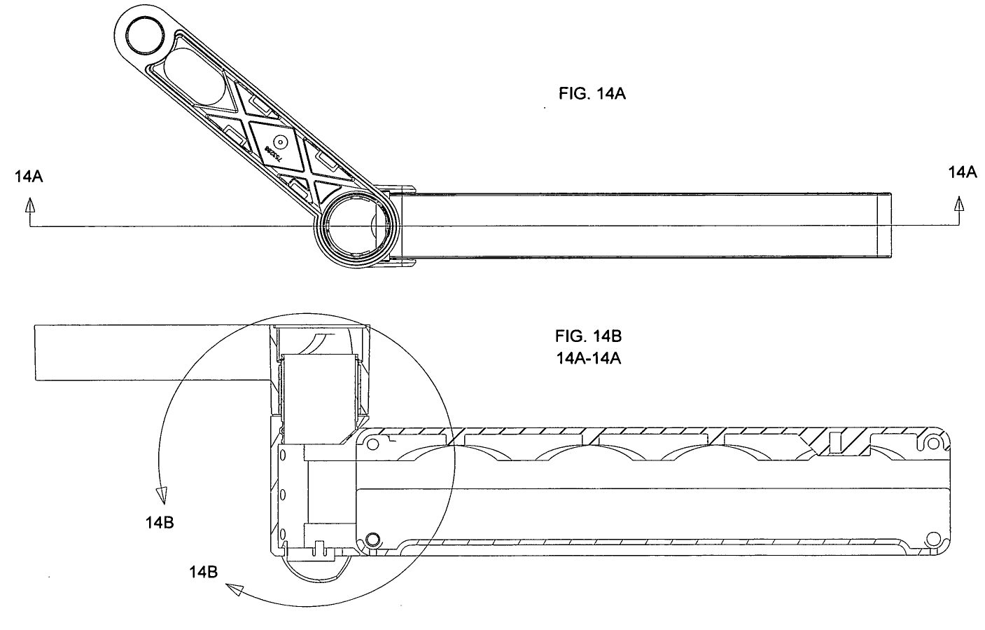

FIG. 13A is a top down view of the configuration shown in FIG. 11D. FIG. 13B is a cutaway view taken along the 13A-13A line of FIG. 13A. And FIG. 13C is an enlarged view of the 13B-13B region of FIG. 13B. As shown in FIG. 13C, the bridge section 430 and the “bird mouth” opening 434 enable the extension arm 450 to extend vertically in a fully down orientation without impinging on the endcap 404 or the tube 406.

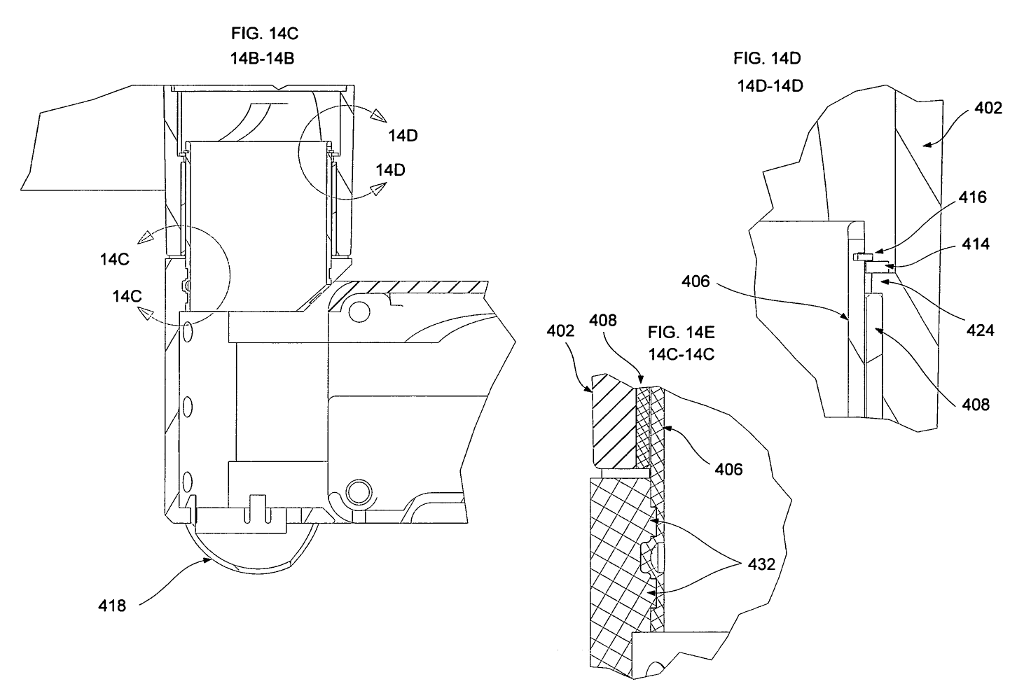

FIG. 14A is a top down view of the configuration shown in FIG. 11F. FIG. 14B is a cutaway view taken along the 14A-14A line of FIG. 14A. FIG. 14C is an enlarged view of the 14B-14B region of FIG. 14B. As shown in FIG. 14C, the extension arm 450 is provided more than adequate clearance from the endcap 404 and the tube 406 while in the horizontal position. FIG. 14D is an enlarged view taken of the 14C-14C region of FIG. 14C, and FIG. 14E is an enlarged view taken of the 14D-14D region of FIG. 14C. FIG. 14D illustrates the coupling of the tube 406 to the forearm extension 402, and FIG. 14E illustrates the formation of the tube 406 with the endcap 404, and their coupling to the forearm extension 402.

Thus, it can be seen that the assembly 400 can be easily and quickly fabricated, and that it permits full maneuverability when coupled to an extension arm.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims. For instance, dimensions for various features of a given component may be scaled up or down, as may be required for manufacturing or for aesthetic purposes. All features for a component may be scaled equally or, as indicated above, certain parts may be of slightly different scale than others. By way of example, a shaft may be scaled down or up in size, such as by approximately 50%, while the cruciform arms and/or radii on the shaft may be scaled down or up in size by between 4°-60%.

Features of each embodiment of the instant invention may be freely used in any of the other embodiments herein. By way of example only, an extension arm may include a pair of endcaps, and each endcap may include the radiused cruciform configuration, the wrought steel cylindrical configuration, or one of each type. And the radiused cruciform and/or the wrought steel cylindrical configurations may be used with the cast tube coupled to a forearm extension. Furthermore, certain claims appended below may include steps of fabricating components. Unless otherwise expressly noted, the steps need not be performed in a given order.

1. A method of fabricating an adjustable extension arm assembly, comprising:
forming a hollow tube structure having a first end, a second end, and at least one generally annular recess disposed about an exterior surface between the first and second ends of the tube structure;
coupling a mold to the hollow tube structure;
casting a first endcap body to form a unitary structure with the tube structure by applying liquid material to the mold so that the first endcap body mechanically bonds to the at least one generally annular recess about the exterior surface of the tube structure; and
affixing an adjustable extension arm member to the tube structure.

2. The method of claim 1, wherein forming the hollow tube structure includes forming an exposed groove about the exterior surface of the tube structure and apart from the at least one generally annular recess.

3. The method of claim 2, further comprising placing a thrust washer about a first portion of the tube structure and securing a snap ring to the exposed groove.

4. The method of claim 3, further comprising, prior to affixing the adjustable extension arm member to the tube structure, fitting a bushing into a bore of the adjustable extension arm member.

5. The method of claim 4, wherein the bore of the adjustable extension arm member includes a shoulder disposed along the interior surface of the bore remote from first and seconds ends thereof, and fitting the bushing into the bore includes inserting the bushing into the bore until the bushing abuts the shoulder.

6. The method of claim 1, wherein the tube structure includes a bird mouth opening at the first end of the first endcap body, and the first endcap body is cast to include an arcuate bridge member disposed over and conforming in shape to the generally arcuate bird mouth opening of the tube structure.

7. An extension arm assembly, comprising:
a unitary endcap assembly including:
a wrought tube structure having a first end, a second end, and at least one generally annular recess disposed about an exterior surface between the first and second ends of the tube structure, the tube structure including a generally arcuate bird mouth opening at the first end thereof; and
a cast first endcap body having a pair of sidewalls connected at one end by an arcuate bridge member and connected at another end by a second bridge member, the first endcap body having an opening at the first end and including at least one generally annular protrusion about an interior surface of the first end, the at least one generally annular protrusion being mechanically bonded to the at least one generally annular recess of the tube structure and the arcuate bridge member conforming in shape to the generally arcuate bird mouth opening of the tube structure, and
a forearm extension having a first end and a second end opposite the first end, the first end including a bore therethrough, wherein the forearm extension is affixed at the bore to the second end of tube structure opposite the first endcap body.

8. The extension arm assembly of claim 7, wherein the forearm extension includes a shoulder disposed along the interior surface of the bore, the shoulder being remote from either end of the bore, the extension arm assembly further comprises a bushing disposed in the bore along a first side of the shoulder and between the interior surface of the bore and the exterior surface of the tube structure.

9. The extension arm assembly of claim 8, further comprising a washer disposed about the tube structure and between the first end of the endcap body and the first end of the forearm extension.

10. The extension arm assembly of claim 8, further comprising a thrust washer disposed about the tube structure adjacent a second side of the shoulder, wherein a thrust load applied to the extension arm assembly is directly applied to the tube structure and is not directly applied to the bushing.

11. The extension arm assembly of claim 7, further comprising:
a first channel member having a first end, a second end opposite the first end, and a pair of sidewalls extending from the first end to the second end;
a second channel member having a first end, a second end opposite the first end, and a pair of sidewalls extending from the first end to the second end; and
a second endcap assembly having first and second ends, the first end being adjustably coupled to the second ends of the first and second channel members;
wherein the first ends of the first and second channel members are adjustably coupled to the pair of sidewalls of the first endcap body, and the generally arcuate bird mouth opening of the tube structure and the arcuate bridge member of the first endcap body provide clearance for the first ends of the first and second channel members to extend fully between a first position and a second position through a maximum range of at least about 90°.

12. The extension arm assembly of claim 11, wherein the maximum range is between about 110° to 130°.

13. A method of fabricating an endcap device for use in an adjustable extension arm, the method comprising:
forming a shaft member by machining a metal rod, the shaft member having a first end and a second end opposite the first end, the first end including a connection region with a recessed area therealong, the recessed area having a generally annular configuration;
coupling a mold to the first end of the shaft member including the connection region; and
casting an endcap body using the mold to form a unitary structure with the shaft member by applying liquid metal to the mold, the endcap body cast to include a first end, a second end opposite the first end, a pair of sidewalls disposed between the first and second ends and an opening therebetween along one side of the endcap body, the first end including a receptacle therein, the receptacle including an inner section, an outer section and a middle section therebetween, the middle section having a generally annular protrusion mechanically bonded to the recessed area of the shaft member connection region.

14. The method of claim 13, wherein the shaft member includes a generally cylindrical shaft extending from the first end of the endcap body, the shaft having an area moment of inertia of at least 0.09 in⁴.

15. The method of claim 13, wherein the shaft member is formed of wrought steel and the shaft has a stiffness of at least 1.45×10⁶ lb-in².

16. The method of claim 13, wherein the generally annular configuration of the connection region recessed area includes radiused edges set at an angle of at least 15° with respect to one another.

17. An endcap assembly, comprising:
a cast endcap body having a first end, a second end opposite the first end, pair of sidewalls disposed between the first and second ends and an opening therebetween along one side of the endcap body, the first end including a receptacle therein, the receptacle including an inner section, an outer section and a middle section therebetween, the middle section having a generally annular protrusion therealong; and
a shaft member having a connection region at a first end thereof mechanically bonded to the inner, middle and outer sections of the receptacle to form a unitary structure therewith, the connection region including a generally annular recessed member coupled to the generally annular protrusion of the receptacle, the shaft member also including a generally cylindrical shaft at a second end thereof remote from the first end of the endcap body, the shaft having an area moment of inertia of at least 0.09 in⁴.

18. The endcap assembly of claim 17, wherein the shaft member is formed of wrought steel and the shaft has a stiffness of at least 1.45×10⁶ lb-in².

19. The endcap assembly of claim 17, wherein the generally annular protrusion of the receptacle includes radiused edges connecting to the inner and outer sections, the radiused edges being set at an angle of at least 20° with respect to one another.

20. An integral one-piece endcap for use with an extension arm assembly, the endcap comprising:
an endcap body having a first end, a second end opposite the first end, a pair of sidewalls disposed between the first and second ends and an opening therebetween along one side of the endcap body; and
a shaft member having a first shaft section formed as an integral one-piece member with the first end of the endcap body and a second shaft section remote from the first end of the endcap body, the first shaft section including a first set of cruciform members and the second shaft section including a second set of cruciform members;
wherein all corners and edges of the first and second sets of cruciform members are fully radiused to reduce stress concentrations therealong.

21. The integral one-piece endcap of claim 20, wherein the first set of cruciform members has a longer length than the second set of cruciform members.

22. An endcap for use with an extension arm assembly, the endcap comprising:
an endcap body having a first end, a second end opposite the first end, a pair of sidewalls disposed between the first and second ends and an opening therebetween along one side of the endcap body; and
shaft means fixedly secured with the first end of the endcap body.
